(19) United States
(12) Patent Application Publication
(10) Pub. No.: US 2021/0267141 A1
(43) Pub. Date: Sep. 2, 2021

(54) MULCH FILM USED IN AGRICULTURE

(71) Applicant: Mark Lloyd Jordan, Clearwater, FL (US)

(72) Inventor: Mark Lloyd Jordan, Clearwater, FL (US)

(21) Appl. No.: 16/804,523

(22) Filed: Feb. 28, 2020

(51) Int. Cl. A01G 13/02; A01N 25/34

(52) U.S. Cl. CPC A01G 13/0275; B32B 2307/41; B32B 2307/416; A01N 25/34

(57) ABSTRACT

An anti-pest film may be provided. The anti-pest film has an upward-facing reflective surface and one or more inner reflective layers overlaying an opaque downward-facing layer. The anti-pest film may include a barrier layer between two inner reflective layers, where sandwiching the barrier layer may be two malaic anhydride layers. The upward-facing reflective surface may be a vacuum metalized layer, and in certain embodiments, the vacuum metalized layer may be embossed for providing a plurality of half ellipsoid indentation for increasing the angles of incidents for reflected sunlight. Additional embodiments may include bookending opaque layers on opposing sides of the vacuum metalized layer.

### BACKGROUND OF THE INVENTION

The present invention relates to mulch film used in agriculture and, more particularly, to a coextruded mulch film with a 100% opaque layer on one side and the other side providing a reflective metallic substrate, where in some embodiments a portion of the reflective metallic substrate may be embossed for reflecting light in thousands of directions to reduce pest populations residing along the underside of plant leaves, promoting plant growth.

Currently, metalized mulch films are often not opaque enough to inhibit weed growth. Other smooth metalized films fall into two (2) categories: (1) those that inhibit weed growth but heat the plant bed when the metallic coating comes off; and (2) those that remain reflective and keep the plant bed cool when the metal comes off but do not inhibit weed growth.

Metalized mulch films are often not opaque enough to inhibit weed growth, while films that inhibit weed growth use a very dark film that shows every imperfection on the metal side. In sum, these films are single purpose items where dual purpose films are required. And as a result, farmers have had to live with one or the other shortcomings of overheated plant beds or weed germination of the available products.

Separately, pests that bring disease generally live on the shaded underside of the plant leaf. Current smooth metalized films do not eliminate all of the shadows under the plant leaves due to the lack of diversity of reflected sunlight, wherein the remaining shadows allow pests to continue to live on the underside of the leaves.

As can be seen, there is a need for a coextruded mulch film with a 100% opaque layer on one side and the other side providing a reflective metallic substrate, wherein a portion of the reflective metallic substrate may be embossed metalized film for reflecting light in thousands of directions to reduce pest populations and promote plant growth. The present invention solves both problems at once by placing a dense black layer on the bottom and a reflective embossed layer in the middle, with a metal layer on top. The opaque layer on the bottom of the mulch film embodied in the present invention inhibits weed growth, while the central reflective layer of the upward/outward-facing film will not show most imperfections in the top metal layer.

The embossed portions embodied in the mulch film, are more reflective and so reflect sunlight from thousands of different directions, reducing the number of shaded areas along the underside of the associated plant's leaves. Each embossed portion is generally a tiny bowl-shaped indentation which creates an array of different angles of incidents, directing the reflective sunlight upwards in thousands of different directions.

### SUMMARY OF THE INVENTION

In one aspect of the present invention, anti-pest film for agriculture includes the following: an upward-facing reflective surface; a downward-facing opaque layer; and one or more inner reflective layers sandwiched between the upward-facing reflective surface and the downward-facing opaque layer.

In another aspect of the present invention, the anti-pest film for agriculture includes the following: an upward-facing vacuum metalized surface embossed with more than a hundred half ellipsoid indentation per square foot for increasing the angles of incidents for reflected sunlight; an opaque layer bookending and coplanar with each longitudinal side the upward-facing vacuum metalized surface; a downward-facing opaque layer; two inner reflective layers sandwiched between the upward-facing vacuum metalized surface and the downward-facing opaque layer; an ethylene vinyl alcohol barrier layer between the two inner reflective layers; and two malaic anhydride layers sandwiching the ethylene vinyl alcohol barrier layer.

In yet another aspect of the present invention, anti-pest film for agriculture includes the following: an upward-facing vacuum metalized surface embossed with more than a hundred half ellipsoid indentation per square foot for increasing the angles of incidents for reflected sunlight; an opaque layer bookending and coplanar with each longitudinal side of the upward-facing vacuum metalized surface.

These and other features, aspects and advantages of the present invention will become better understood with reference to the following drawings, description and claims.

### BRIEF DESCRIPTION OF THE DRAWINGS

FIG. 1 is a section view of an exemplary embodiment of an embossed portion of an anti-pest film of the present invention, illustrating the embossed portion's reflection of sunlight;

FIG. 2 is a section view of a common plastic mulch film of the prior art, illustrating the unidirectional reflective nature of sunlight reflecting off of it;

FIG. 3 is a perspective view of an exemplary embodiment of a roll of the anti pest film of the present invention, as well as an enlarged view of a plurality of embossed indentations;

FIG. 4 is a perspective view of an exemplary embodiment of the present invention, shown in use;

FIG. 5 is a perspective view of an exemplary embodiment of a section of layer the present invention;

FIG. 6 is a perspective view of an exemplary embodiment of a section of layer the present invention; and

FIG. 7 is a graphical view of the advantages of the present invention in terms of mulch film reflectance vs. absorption of chlorophyll.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an anti-pest film having a plurality of layers so as to provide an upward-facing reflective surface and one or more inner reflective layers overlaying an opaque downward-facing layer. The anti-pest film may include a barrier layer between two inner reflective layers, where sandwiching the barrier layer may be two malaic anhydride layers. The upward-facing reflective surface may be a vacuum metalized layer, and in certain embodiments, the vacuum metalized layer may be embossed for providing a plurality of half ellipsoid indentation for increasing the angles of incidents for reflected sunlight. Additional embodiments may include bookending opaque layers on opposing sides of the vacuum metalized layer.

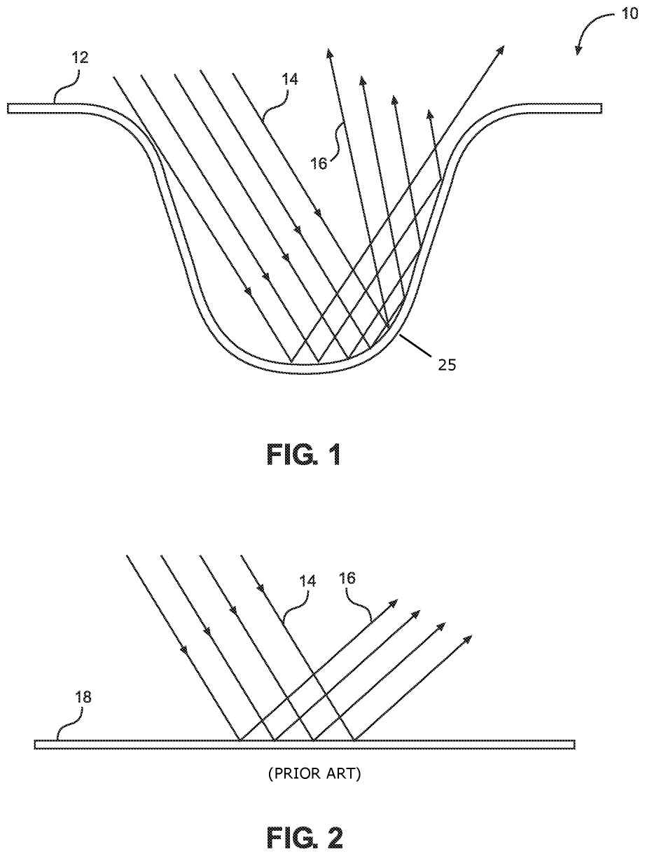

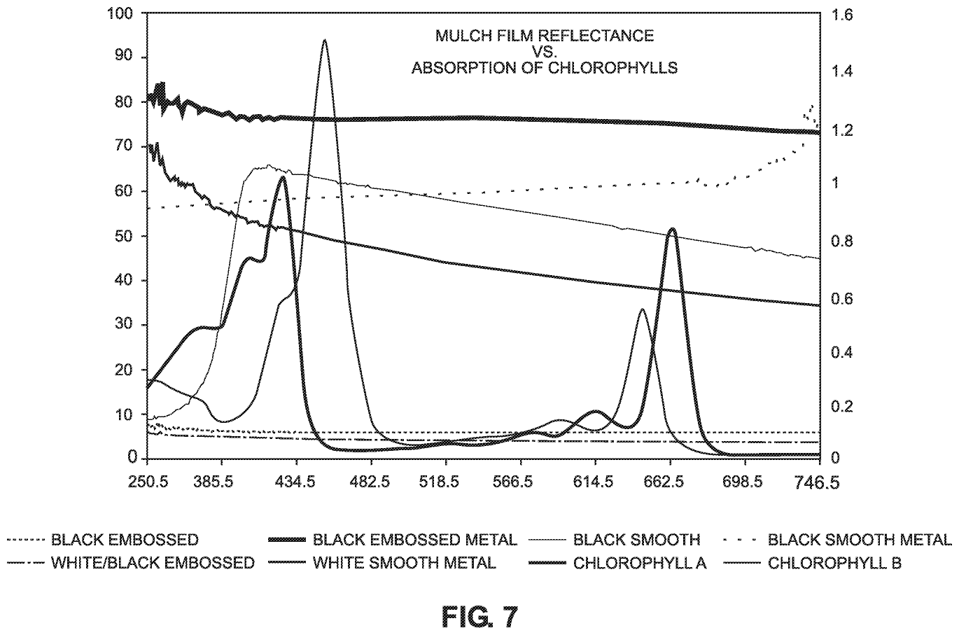

Referring to FIGS. 1 through 7, the present invention may include an anti-pest film 10. The anti-pest film 10 may include a coextruded film having a plurality of layers which allows the anti-pest film 10 to be a reflective color on a first side 51 and a dense, opaque dark color on the opposing second side 52. The layers may include a barrier layer 34, such as nylon, Ethylene vinyl alcohol (EVOH), PVDC or the like, a skin layer 28, an opaque layer 30, and a reflective layer 32, a malaic anhydride layer 36, a vacuum metalized layer 38 usually made of aluminum or similar metal or a combination of two or three of these to be used as the barrier layer 34.

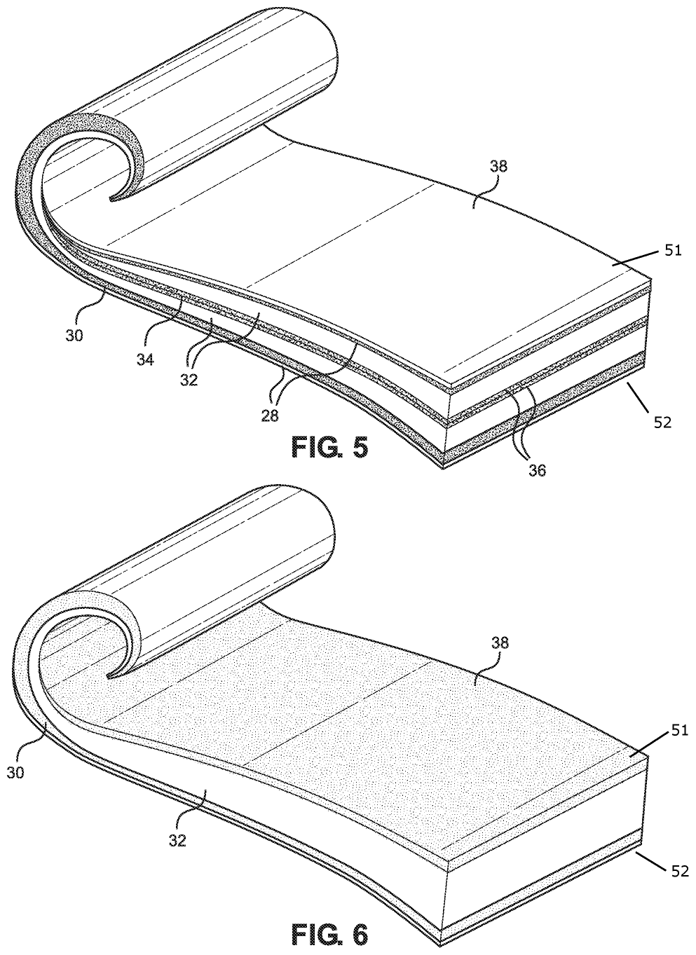

In one embodiment, the anti-pest film 10 may include, from the first side 51 to the second side 52, the vacuum metalized layer 38, a skin layer 28, two reflective layers 32 sandwiching two malaic anhydride layers 36 themselves sandwiching the barrier layer 34, an opaque layer 30, and another skin layer 28 downward/outward-facing on the second side 52, as illustrated in FIG. 5.

In another embodiment, the anti-pest film 10 may include, from the first side 51 to the second side 52, the vacuum metalized layer 38, a reflective layer 32, and the opaque layer 30 adjacent to the second side 52, as illustrated in FIG. 6.

This anti-pest film 10 can be blown smooth or blown smooth and post embossed, or cast flat, or cast embossed.

The dense dark layer blocks light from passing through the anti-pest film 10, thereby preventing the germination of weeds in the soil over which the anti-pest film 10 lays. The reflective center layer stays reflective even if the metalized top layer 38 is destroyed by weather or agricultural chemicals. The metalized top layer 38 reflects sunlight to the underside of the plant leaves and causes any pests like aphids or whiteflies to move to another field, controlling the spread of disease.

A method of manufacturing the present invention may include the following. A manufacturer may coextrude a nominal 1 mil sheet with a dense black layer 30 that makes up 10% to 90% of the cross section and a reflective white layer 32 that encompasses 10% to 90% of cross section of the sheet. In one embodiment the coextruded anti-pest film 10 has skin layers 28 of from 2% to 22% of the top side and bottom side of the anti-pest film 10. These skin layers 28 is a sufficient carrier of or otherwise adapted to allow process aids and/or UV inhibitors to be added to the top and bottom of the anti-pest film 10. The cross section may also include the barrier layer 34. The layers on either side of the barrier layer 34 may include a malaic anhydride adhesive layer 36 to keep the anti-pest film 10 together. The reflective white layer 32 should be corona treated anywhere from 36 up to 46 dynes. The anti-pest film 10 may be wound into master rolls and taken to a second operation where the reflective side is vacuum metalized. In the absence of alternatives, the metalization is necessary. The skin layers 28 and the barrier layers 34 are optional.

A method of using the present invention may include the following. The anti-pest film 10 disclosed above may be provided. A user may, like regular plastic mulch film, unroll or lay the anti-pest film 10 over agricultural soil used for planting crops or plants 26; for example, on a raised plant bed. Unlike the current plastic mulch film, because the anti-pest film 10 is coextruded, the present invention blocks the light that would germinate weeds, while remaining reflective even if some of the metallic layer 38 comes off.

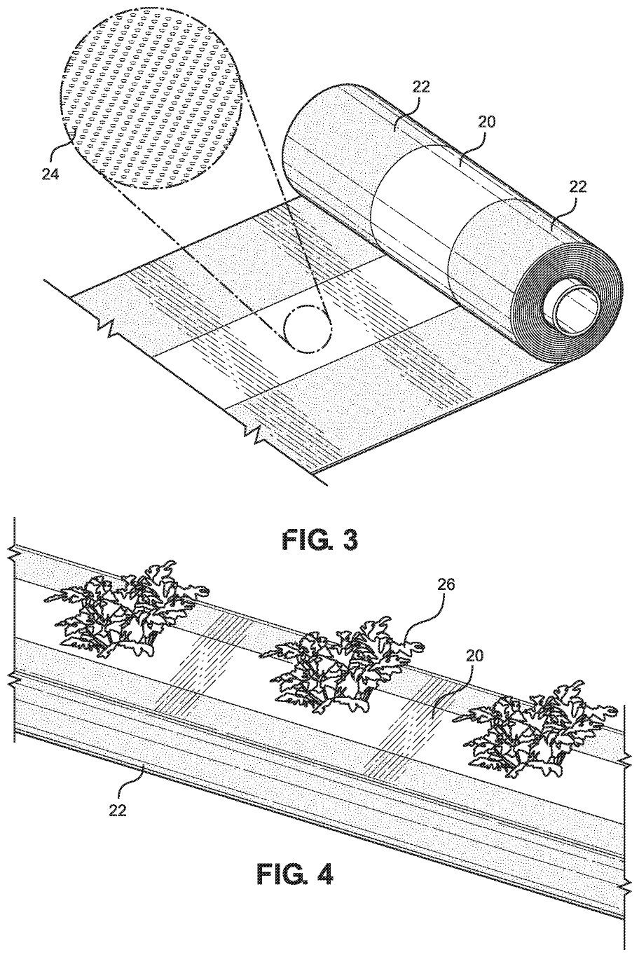

In certain embodiments of the present invention, the anti-pest film 10 may include a central portion 20 bookended by two shoulder portions 22, as illustrated in FIG. 3. The central portion 20 may be linear low-density polyethylene (LLDPE) mulch film. The central portion 20 may be coated with vacuum evaporated aluminum layer for providing a reflective surface 12.

The outward-facing reflective surface 12 of the central portion 20 may be embossed 24 so as to have a plurality of indentations 25. Each indentation 25 may be bowl-shaped or having a semi, hemi or half spheroid or ellipsoid shape. The curvature of each indentation 25 results in a reflective surface that enables innumerable angles of incidents between direct sunlight 14 and the resulting reflected sunlight 16, as illustrated in FIG. 1.

The thousands of differently-directed/reflected sunlight 16 reduces the number of shaded areas on the underside of the leaves of plants 26 supported by the anti-pest film 10. In contrast to the flat reflective surface of the prior art, as illustrated in FIG. 2.

A method of manufacturing the present invention may include the following. A manufacturer may first acquire or manufacture an embossed LLDPE based mulch film roll that may contain a nylon, PVDC, PVOH, or EVOH barrier layer 34, which is held in place with maleic anhydride layers 38, as disclosed above. Second, the manufacturer may put the roll in a vacuum metalizing chamber and evaporate aluminum or gold or similar metal onto the underside of the film.

The barrier layers 34 and maleic anhydride layers 38 may be added. However, using a barrier layer 34 with maleic anhydride layers 38 makes the anti-pest film 10 better contain any fumigant that might be used to sterilize the soil before planting.

It should be understood, of course, that the foregoing relates to exemplary embodiments of the invention and that modifications may be made without departing from the spirit and scope of the invention as set forth in the following claims.

What is claimed is:

1. An anti-pest film for agriculture, comprising:
an upward-facing reflective surface;
a downward-facing opaque layer; and
one or more inner reflective layers sandwiched between the upward-facing reflective surface and the downward-facing opaque layer.

2. The anti-pest film for agriculture of claim 1, wherein the one or more inner reflective layers are two inner reflective layers; and
a barrier layer between the two inner reflective layers.

3. The anti-pest film for agriculture of claim 2, wherein the barrier layers is ethylene vinyl alcohol.

4. The anti-pest film for agriculture of claim 2, further comprising two malaic anhydride layers sandwiching the barrier layer.

5. The anti-pest film for agriculture of claim 1, wherein the upward-facing reflective surface is embossed with more than a hundred half ellipsoid indentation per square foot for increasing the angles of incidents for reflected sunlight.

6. The anti-pest film for agriculture of claim 5, further comprising an opaque layer bookending and coplanar with the upward-facing reflective surface.

7. The anti-pest film for agriculture of claim 1, wherein the upward-facing reflective surface is a vacuum metalized layer.

8. An anti-pest film for agriculture, comprising:
an upward-facing vacuum metalized surface embossed with more than a hundred half ellipsoid indentation per square foot for increasing the angles of incidents for reflected sunlight;
an opaque layer bookending and coplanar with each longitudinal side the upward-facing vacuum metalized surface;
a downward-facing opaque layer;
two inner reflective layers sandwiched between the upward-facing vacuum metalized surface and the downward-facing opaque layer;
an ethylene vinyl alcohol barrier layer between the two inner reflective layers; and
two malaic anhydride layers sandwiching the ethylene vinyl alcohol barrier layer.

9. An anti-pest film for agriculture, comprising:
an upward-facing vacuum metalized surface embossed with more than a hundred half ellipsoid indentation per square foot for increasing the angles of incidents for reflected sunlight;
an opaque layer bookending and coplanar with each longitudinal side of the upward-facing vacuum metalized surface.
